(19) United States
(12) Patent Application Publication
(10) Pub. No.: US 2025/0384342 A1
(43) Pub. Date: Dec. 18, 2025

(54) LEARNING DEVICE, LEARNING METHOD, AND RECORDING MEDIUM

(71) Applicant: NEC Corporation, Tokyo (JP)

(72) Inventor: Yuki NAKAGUCHI, Tokyo (JP)

(73) Assignee: NEC Corporation, Tokyo (JP)

(21) Appl. No.: 19/233,160

(22) Filed: Jun. 10, 2025

(30) Foreign Application Priority Data
Jun. 17, 2024 (JP) 2024-097467

(51) Int. Cl. G06N 20/00

(52) U.S. Cl. CPC G06N 20/00

(57) ABSTRACT

In a learning device, a generation means generates a value estimation model from preference data indicating combinations of each state and action. An acquisition means acquires a next state as an execution result of an action determined using a strategy of a learning target model. An estimation means estimates a state value or action value of a next state using the next state and the value estimation model. A strategy update means updates the strategy of the learning target model using the state value or the action value. Accordingly, it is possible to realize interactive imitation learning that can be performed with offline data indicating preferences for a teacher model.

### TECHNICAL FIELD

This disclosure relates to imitation learning in reinforcement learning.

### BACKGROUND ART

In reinforcement learning, methods have been proposed that use imitation learning for policy learning. The imitation learning is a technique for learning a policy. The policy is a model that determines a next action for a certain state. Among imitation learning methods, interactive imitation learning learns the policy by referencing a teacher model rather than action data. Several methods have been proposed for the interactive imitation learning, such as methods that use a policy of a teacher as the teacher model, or methods that use a value function of the teacher as the teacher model. Furthermore, even in methods that use the value function of the teacher as the teacher model, there are methods that use a state value, which is a function of a state, as the value function, or methods that use an action value, which is a function of the state and an action.

One example of the interactive imitation learning is disclosed in Non-Patent Document 1, which proposes a method for learning a policy by introducing a parameter k that truncates certain rewards when computing an expected discounted cumulative reward, and simultaneously performing reward shaping using the teacher model.
Non-Patent Document 1: Wen Sun, J. Andrew Bagnell, Byron Boots, “Truncated Horizon Policy Search: Combining Reinforcement Learning & Imitation Learning”, ICLR 2018.

### SUMMARY

Because interactive imitation learning leverages online feedback from a teacher model, applicable teacher models are limited. In particular, a value function of the teacher model is necessary for efficient learning.

One object of the present disclosure is to provide a technology of the interactive imitation learning that can be performed with offline data indicating preferences for the teacher model.

In one aspect of the present disclosure, a learning device includes:
at least one memory configured to store instructions; and
at least one processor configured to execute the instructions to:
generate a value estimation model from preference data indicating combinations of each state and action;
acquire a next state as an execution result of an action determined using a strategy of a learning target model; and
estimate a state value or action value of a next state using the next state and the value estimation model; and
update the strategy of the learning target model using the state value or the action value.

In another aspects of this disclosure, a learning method performed by a computer, includes:
generating a value estimation model from preference data indicating combinations of each state and action;
acquiring a next state as an execution result of an action determined using a strategy of a learning target model;
estimating a state value or action value of a next state using the next state and the value estimation model; and
updating the strategy of the learning target model using the state value or the action value.

In a further aspect of this disclosure, a non-transitory computer-readable recording medium storing a program causing a computer to execute processing of:
generating a value estimation model from preference data indicating combinations of each state and action;
acquiring a next state as an execution result of an action determined using a strategy of a learning target model;
estimating a state value or action value of a next state using the next state and the value estimation model; and
updating the strategy of the learning target model using the state value or the action value.

### Effect

According to the present disclosure, it is possible to provide a technology of interactive imitation learning that can be performed with offline data indicating preferences for a teacher model.

### BRIEF DESCRIPTION OF THE DRAWINGS

FIG. 1 is a block diagram illustrating a hardware configuration of a learning device.

FIG. 2 is a block diagram illustrating a functional configuration of the learning device.

FIG. 3 is a flowchart of a student model learning process by the learning device.

FIG. 4 is a block diagram illustrating a functional configuration of another learning device.

FIG. 5 is a flowchart of a process by the other learning device.

### EXAMPLE EMBODIMENTS

Preferred example embodiments of the present disclosure will be described with reference to the accompanying drawings.

### Exposition of Principle

### (1) Imitation Learning

In a problem of reinforcement learning, imitation learning learns a student model (also called “learning target model” or simply “model”) seeking measures by utilizing information from a teacher model which is a model. In this case, the teacher model may be any of a human, an animal, an algorithm, and the like. Behavioral cloning, which is a typical technique for imitation learning, is vulnerable to conditions with little or no data, because the behavioral cloning is simply a technique for supervised learning of a state of the teacher model and historical data of behavior. Therefore, in a case where the student model that has been trained is actually operated, deviation between the student model and the teacher model is amplified with time, and the behavioral cloning can be used only for a short-term problem.

Interactive imitation learning is to solve the above problem by giving a student under learning online feedback from the teacher model instead of the historical data. However, since interactive imitation learning requires the online feedback from the teacher model, i.e., feedback at any time, the applicable teacher models are limited. Especially, for efficient learning, a value function of the teacher model is necessary.

Therefore, the method of this embodiment (hereinafter, also referred to as a “present method”) generates an action value function based on offline data indicating the preference of the teacher model, and performs the interactive imitation learning by estimating the action value or a state value of the teacher model using the generated action value function. Thus, in the present disclosure, the value function of the teacher model is not required, and the interactive imitation learning can be performed based on the offline data which indicates the preference of the teacher model.

### (2) Glossary

The followings are explanations of relevant terminologies prior to describing example embodiments.

### (2-1) Objective Function and Optimal Strategy for Reinforcement Learning

An expected discounted cumulative reward J[π] shown in a formula (1) is typically used as an objective function of the reinforcement learning.

$$[ Math 1 ]$$

$$J [ π ] ≡ {𝔼}_{{p}_{0} , T , π} [ {\sum }_{t = 0}^{∞} {γ}^{t} r ( {s}_{t} , {a}_{τ} ) ] \qquad ( 1 )$$

In the formula (1), the following reward function r represents the expected value of a reward r obtained if an action a is performed in a state s.

$$[ Math 2 ]$$

$$r ( s , a ) ≡ {𝔼}_{p ( r \vert s , a )} [ r ]$$

Also, a discount factor γ below represents a factor for discounting a value in a case of evaluating the future reward value at present.

$$[ Math . 3 ]$$

$$γ ∈ [ 0 , 1 )$$

In addition, an optimal strategy shown below is a strategy to maximize the objective function J.

$$[ Math 4 ]$$

$${π}^{*} ≡ arg {max}_{π ∈ Π} J [ π ]$$

### (2-2) Value Function

The value function is a representation of the objective function J[π] as a function of an initial state so and an initial behavior a₀. The value function represents expected discounted cumulative reward to be acquired in the future if the state and action is taken. A state value function and the action value function are expressed by the following formulae (2) and (3). The state value function and the action value function when entropy regularization is introduced into the objective function J[π] are expressed by the following formulae (2x) and (3x).

$$[ Math 5 ]$$

$$STATE VALUE FUNCTION : {V}^{π} ( s ) ≡ {𝔼}_{T , π} [ {\sum }_{t = 0}^{∞} {γ}^{t} r ( {s}_{t} , {a}_{t} ) \vert {s}_{0} = s ] \qquad ( 2 )$$

$$WITH NORMALIZATION : {V}^{π} ( s ) ≡ {𝔼}_{T , π} [ {\sum }_{t = 0}^{∞} {γ}^{t} ( r ( {s}_{t} , {a}_{t} ) + {β}^{- 1} {H}^{π} ( {s}_{t} ) ) \vert {s}_{0} = s ] \qquad ( 2 x )$$

$$ACTION VALUE FUNCTION : {Q}^{π} ( s , a ) ≡ {𝔼}_{T , π} [ {\sum }_{t = 0}^{∞} {γ}^{t} r ( {s}_{t} , {a}_{t} ) \vert {s}_{0} = s , {a}_{0} = a ] \qquad ( 3 )$$

$$WITH NORMALIZATION : {Q}^{π} ( s , a ) ≡ {𝔼}_{T , π} [ {\sum }_{t = 0}^{∞} {γ}^{t} ( r ( {s}_{t} , {a}_{t} ) + {β}^{- 1} {H}^{π} ( {s}_{t} ) ) \vert {s}_{0} = s , {a}_{0} = a ] - {β}^{- 1} {H}^{π} ( {s}_{0} ) \qquad ( 3 x )$$

Also, the optimal value function is obtained by the following formula.

$$[ Math 6 ]$$

$${V}^{*} = {max}_{π} {V}^{π} = {V}^{π *} \\ {Q}^{*} = {max}_{π} {Q}^{π} = {Q}^{π *}$$

### (3) Interactive Imitation Learning

The interactive imitation learning is a technique which gives online feedback from the teacher model to the student model under learning, instead of the historical data of the teacher model. Examples of the interactive imitation learning include the followings.

### (3-1) Type in which the Teacher Teaches the Action a^{e}=π^{e}(s) to be Taken in Each State s

A method of this type is DAgger. Note that π^{e} is a strategy of the teacher.

### (3-2) Type in which the Teacher Teaches the Value of the Action a in Each State s

Methods of this type include AggreVate, AggreVaTeD, and the non-patent method (hereafter referred to as “THOR (Truncated Horizon Policy Search)”). and others. Specifically, AggreVate and AggreVateD are methods that teach an action value Q^{e}(s,a) of the teacher, and THOR is a method that teaches a state value V^{e}(s) of the teacher.

Note that a detailed description of THOR is described in the following document (Non-Patent Document 1). This document is incorporated herein by reference.
Wen Sun, J. Andrew Bagnell, Byron Boots, “Truncated Horizon Policy Search: Combining Reinforcement Learning & Imitation Learning”, ICLR 2018.

### (4) Technique of the Present Example Embodiment

### (4-1) Basic Principle

In performing interactive imitation learning, it may be difficult or costly to prepare the offline data on the teacher model and a trajectory of the teacher that can be fed back online. For example, operations of robots with many degrees of freedom, advanced language processing, etc. are difficult for the teacher such as a human, to perform desirable behavior, and it is difficult to prepare the offline data of the trajectory of the teacher (time series of the state and action). Even in such cases, it may be possible to prepare the teacher that can determine only superiority or inferiority by comparison of behaviors, that is, the offline data indicating the preferences of the state and action of the teacher (hereinafter also referred to as ‘preference data’).”

Accordingly, in the present disclosure, an action value function Q of the teacher model is generated from the offline data indicating the preferences over the state and action of the teacher model. The action value function Q is a function for estimating the action value or state value of the teacher model, and corresponds to an example of the value estimation model of the present disclosure. Then, this technique estimates the state value and the action value of the teacher model using the obtained behavior value function Q, and performs the interactive imitation learning. As a result, this approach allows for utilization of such preference data, thereby reducing the need for exploration from scratch and enabling efficient learning with limited data.

### (4-2) RLHF

This technique utilizes a RLHF (Reinforcement Learning from Human Feedback) method in generating the behavior value function Q of the teacher model from the offline data indicating the preferences of the state of the teacher model of the action. The RLHF is a technique in which a reward function is learned from the preference data of the human offline, and the reinforcement learning is carried out using the reward function. Therefore, prior to the concrete explanation of this technique, a typical technique of the RLHF will be described,

In addition, the preference refers to a binary relationship indicating which of two different options is preferred. In this specification, in mathematical formulae, a symbol indicating the preference (Unicode name: Succeeds/Precedes) is used to denote the preference, except in the mathematical formulae, the symbol indicating the preference is sometimes substituted by an unequal symbol “<” or “>” for convenience. For example, if a is preferred to b, it is written a>b or b<a.

In a typical RLHF approach, a probability of the preference between trajectories shown in the following formula (4) are modeled with a Bradley-Terry model using the discounted cumulative reward of the trajectory shown in the following formula (5) as a score function.

$$[ Math 7 ]$$

$$τ = {\{ ( {s}_{t} , {a}_{t} ) \}}_{t = 0 , 1 , … , T} \qquad ( 4 )$$

$$J [ τ ] ≡ {\sum }_{t = 0}^{T} {γ}^{t} r ( {s}_{t} , {a}_{t} ) \qquad ( 5 )$$

Note that the trajectory is time series data of a combination of the state s and the action a.

Specifically, the probability that the preference between trajectories τ and τ′ becomes τ>τ′ is modeled as the following formula (6). The formula (6) is referred to as a probability model.

$$[ Math 8 ]$$

$$p ( τ ≻ {τ}^{′} ) = \frac{{e}^{J [ τ ]}}{{e}^{J [ τ ]} + {e}^{J [ {τ}^{′} ]}} = σ ( J [ τ ] - J [ {τ}^{′} ] ) \\ σ ( s ) ≡ \frac{1}{1 + {e}^{- x}} \qquad ( 6 )$$

In this model, while guaranteeing the following formula (7), the trajectory with a higher score J is preferred over other trajectories, with a probability proportional to e^{ΔJ} where ΔJ denotes a score difference in a formula (8).

$$[ Math 9 ]$$

$$p ( τ ≻ {τ}^{′} ) + p ( τ ≺ {τ}^{′} ) = 1 \qquad ( 7 )$$

$$Δ J ≡ \vert J [ τ ] - J [ {τ}^{′} ] \vert \qquad ( 8 )$$

Here, by introducing a parameter θ and parameterizing the reward function r as r=r_{θ}, the discounted cumulative reward J[τ] of the trajectory is parameterized as J_{θ}[τ], and a probability model p is parameterized as pe. This probability model P_{θ} is interpreted as the probability model of a binary classification of τ>τ′ and τ<τ′, and the reward function r=r_{θ} is learned by determining the parameter θ so as to minimize a loss of the binary classification. For example, as the loss, the cross-entropy loss shown in a formula (9) is used.

$$[ Math 10 ]$$

$$L ( θ ) = {𝔼}_{τ > - {τ}^{′}} [ - log {p}_{θ} ( τ ≻ {τ}^{′} ) ] \qquad ( 9 )$$

Specifically, the loss is obtained by approximating a loss L(θ) using the preference data prepared in advance, to obtain a reward function re by optimizing the parameter θ so as to minimize the loss L(θ).

The preference data are used to present, for example, a plurality of combinations of each state s and action a (hereinafter, also referred to as “steps”.) (s,a) to the teacher such as a human, and are prepared in advance by obtaining preference ranking. The preference data may be two-choice superiority data such as A/B testing, or may indicate multiple level rankings such as a 5-point rating questionnaire, ranking data, or the like. In a case where the preference data indicate multiple levels of ranking, the preference between trajectories τ and τ′ can be determined using superiority or inferiority between any two of those ranks.

In a case of learning of a language model, a prompt given to the language model is considered to be the state s and an answer of the language model to the prompt is considered to be the action a, and time is considered to be a one-step reinforcement learning problem. In this case, the length of the trajectory is 1, and becomes 1, and by gathering the preference data among several answers a with the prompt kept consistent, this data can serve as the preference data between trajectories τ=(s,a).

Thus, according to this RLHF approach, the reward function can be obtained based on the preference data of the state s and the action a. However, as described above, in order to perform interactive imitation learning, for the teacher model, the value function, which indicates the expected discounted cumulative reward to be obtained in the future by the state s and the action a which are determined based on the reward function, is necessary. In order to obtain the value function, it is necessary to carry out the reinforcement learning on this reward function.

Incidentally, representative paper on RLHF can be found in Document 1 below, and the starting point for RLHF can be found in Document 2 below. Documents 1 and 2 below are incorporated herein by reference.
(Document 1) Long Ouyang, et. al., “Training language models to follow instructions with human feedback”, NeurIPS 2022, https://arxiv.org/abs/2203.02155
(Document 2) Paul Christiano, et. al., “Deep reinforcement learning from human preferences”, NeurIPS 2017, https://arxiv.org/abs/1706.03741

### (4-3) Technique in the Present Disclosure

A technique uses the RLHF approach described above to learn an action value function Q based on the offline data indicating preferences of the state and action of the teacher model. Then, the interactive imitation learning is executed using the obtained action value function Q.

The RLHF described above uses the trajectory of the teacher model, i.e., the time series of the state and action. In contrast, this technique does not restrict the time to a single step, and even in the reinforcement learning problem where the length of the trajectory is greater than one, it uses the preference data between single steps (s,a) of the trajectory, rather than preferences between entire trajectories. That is, the probability of the preference between one steps (s,a) is modeled by a Bradley-Terry model. Since the expected value of the discounted cumulative reward of the trajectory starting from the step (s,a) is Q(s,a), the action value function Q(s,a) corresponding to the discounted cumulative reward J[π] of the trajectory is used as the score of step (s,a).

Incidentally, considering the potential for a scale difference compared to the actual teacher model's value, a positive constant (α>0), a hyperparameter a can be introduced, and the score of the step (s,a) can be taken as αQ(s,a). For simplicity, the hyperparameter a may be set to 1. Also, in a case where of including entropy regularization, an inverse temperature β>0 may be used. In the following, a case where the hyperparameter a is used will be described.

Specifically, a probability that the preference between steps (s,a) and (s′, a′) indicates (s,a)>(s′, a′) is modeled by the probability model of a formula (10).

$$[ Math 11 ]$$

$$p ( ( s , a ) ≻ ( {s}^{′} , {a}^{′} ) ) = \frac{{e}^{α Q ( s , a )}}{{e}^{α Q ( s , a )} + {e}^{α Q ( {s}^{′} , {a}^{′} )}} = σ ( α ( Q ( s , a ) - Q ( {s}^{′} , {a}^{′} ) ) ) \qquad ( 10 )$$

In this probability model, while guaranteeing the following formula (11), the step with a higher score αQ is preferred over other steps, with a probability proportional to e^{αΔQ} where ΔQ denotes a score difference in a formula (12).

$$[ Math 12 ]$$

$$p ( ( s , a ) ≻ ( {s}^{′} , {a}^{′} ) ) + p ( ( s , a ) ≺ ( {s}^{′} , {a}^{′} ) ) = 1 \qquad ( 11 )$$

$$Δ Q ≡ \vert Q ( s , a ) - Q ( {s}^{′} , {a}^{′} ) \vert \qquad ( 12 )$$

Here, Here, the parameter θ is introduced and the value function Q is parametrized as Q=Q_{θ}, and this probability model p is parametrized as p_{θ}. By interpreting this probability model pe as a probability model of binary classification of (s,a)>(s′, a′) or (s,a)<(s′, a′), and determining the parameter θ to minimize the loss of the binary classification, the value function Q=Q_{θ} is learned. For example, as the loss, a cross-entropy loss shown in the following formula (13) is used.

$$[ Math 13 ]$$

$$L ( θ ) = {𝔼}_{( s , a ) ≻ ( {s}^{′} , {a}^{′} )} [ - log {p}_{θ} ( ( s , a ) ≻ ( {s}^{′} , {a}^{′} ) ) ] \qquad ( 13 )$$

Specifically, the value function Q_{θ} is obtained by approximating the loss L(θ) using the preference data prepared in advance and optimizing the parameter θ so as to minimize the loss L(θ). Thus, in this technique, the value function can be obtained from the preference data, that is, the off-line data indicating the preference of the state and action of the teacher model.

For simplicity, in acquiring the preference data, after aligning the status s, it may be the preference data between steps (s,a) by acquiring preference data between some actions a. In that case, the probability model p can be transformed into a formula by the strategy π of the teacher model shown in a formula (15) using an expression of the optimal strategy shown in a formula (14).

$$[ Math 14 ]$$

$$π ( a \vert s ) = {e}^{β Q ( s , a )} / {\sum }_{a} {e}^{β Q ( s , a )} \qquad ( 14 )$$

$$p ( ( s , a ) ≻ ( {s}^{′} , {a}^{′} ) ) = σ ( \frac{α}{R} ( log π ( a \vert s ) - log ( {a}^{′} \vert s ) ) ) \qquad ( 15 )$$

Therefore, similarly to the approach described above, the strategy π of the teacher model can also be learned by parametrizing the strategy π with the parameter θ as π=π_{θ}.

### (4-4) Application to the Interactive Imitation Learning

Next, the method of applying the action value function Q obtained as described above to the interactive imitation learning will be described.

### (4-4-1) Application to the Interactive Imitation Learning of the Type that Teaches the Action Value of the Teacher

For the interactive imitation learning of the type for teaching the teacher action value Q^{e}(s,a) of the teacher in the state s of the student, such as AggreVate and AggreVateD, in this technique, the state s and action a at each time are input into the action value function Q obtained as described above in order to calculate the action value function Q(s,a), and a value acquired is thus given to the student model as the action value Q^{e}(s,a).

### (4-4-2) Application to the Interactive Imitation Learning of the Type that Teaches the State Value of the Teacher

A method of applying to the interactive imitation learning of the type that teaches the state value V^{e}(s) of the teacher in the state s such as THOR will be classified as follows.

### 4-4-2-1

In a case where an action set A is discrete and small, and a sum over actions a∈A can be explicitly performed, for each state s, the sum over the actions a∈A of the first relation shown in a formula (16) is explicitly executed using the action value function Q obtained by learning, and the calculated value is given to the student model as a state value V^{e} of the teacher model.

$$[ Math 15 ]$$

$$V ( s ) = {β}^{- 1} log {\sum }_{a ∈ 𝒜} {e}^{β Q ( s , a )} \qquad ( 16 )$$

### 4-4-2-2

On the other hand, in a case where the action set A is continuous or huge and the sum for the actions a∈A is not specifically feasible, the strategy π of the teacher model is learned in addition to the action value function Q as described above. Then, the expected value of a second relational expression shown in a formula (17) is calculated by approximating it with a sample generated from the action value function Q and the strategy π which have been obtained by the learning, and the expected value obtained is given to the student model as the state value V^{e} of the teacher model.

$$[ Math 16 ]$$

$$V ( s ) = {𝔼}_{π ( a \vert s )} [ Q ( s , a ) - {β}^{- 1} log π ( a \vert s ) ] \qquad ( 17 )$$

As described above, according to this technique, it is possible to realize the interactive imitation learning by estimating the state value V^{e} or the action value Q^{e} of the teacher using the value function or using the value function and the strategy, which have been learned from data indicating the preference of the state and action of the teacher, and by giving the estimated value to the student model. Therefore, even in a case where there is no trajectory data of the teacher (that is, time series data of the state and action), if there is offline data indicating the preference of the state and action of the teacher, it is possible to realize the interactive imitation learning.

### First Example Embodiment

Next, a learning device according to a first example embodiment will be described. A learning device 100 according to the first example embodiment is a device that learns the student model using the technique described above.

### [Hardware Configuration]

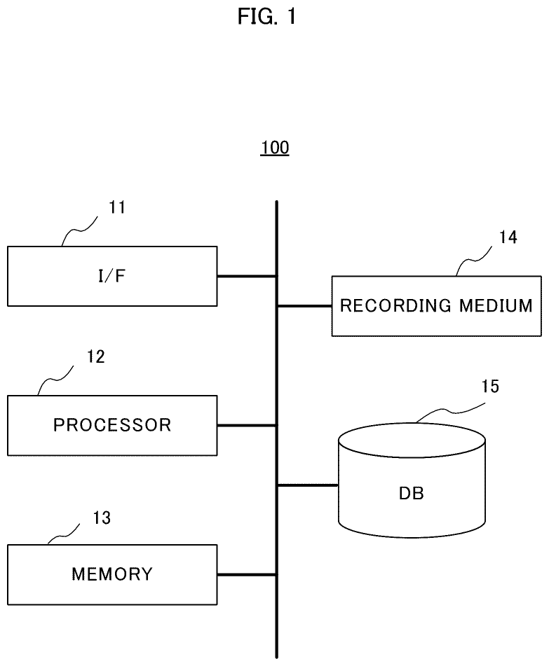

FIG. 1 is a block diagram illustrating a hardware configuration of the learning device 100 according to the first example embodiment. As shown in FIG. 1, the learning device 100 includes an interface (I/F) 11, a processor 12, a memory 13, a recording medium 14, and a database (DB) 15.

The I/F 11 inputs and outputs data to and from an external device. For example, in a case where an agent by reinforcement learning of the present example embodiment is applied to an automated vehicle, the I/F 11 acquires outputs of various sensors mounted on the vehicle as a state in an environment, and outputs an action to various actuators controlling a travel of the vehicle.

The processor 12 is a computer, such as a CPU (Central Processing Unit), and controls the entire learning device 100 by executing a predetermined program. The processor 12 may be a GPU (Graphics Processing Unit), a DSP (Digital Signal Processor, a MPU (Micro Processing Unit), a FPU (Floating Point number Processing Unit), a PPU (Physics Processing Unit), a TPU (Tensor Processing Unit), a quantum processor, a microcontroller, or a combination thereof. The processor 12 executes a student model learning process which will be described later.

The memory 13 is formed by a ROM (Read Only Memory) and a RAM (Random Access Memory). The memory 13 is also used as a working memory during processes of various operations by the processor 12.

The recording medium 14 is a non-volatile and non-transitory recording medium such as a disk-shaped recording medium, a semiconductor memory, or the like, and is configured to be detachable to the learning device 100. The recording medium 14 records various programs executed by the processor 12. In a case where the learning device 100 executes various types of processes, corresponding programs recorded in the recording medium 14 are loaded into the memory 13 and executed by the processor 12.

The DB 15 stores data which the learning device 100 uses for learning. For example, the DB 15 stores data related to the teacher model used for learning, specifically, offline data indicating a preference of the state and action of the teacher model. In addition, the DB 15 stores data such as a sensor output that indicates the state of a target environment that is input through the I/F 11.

### (Functional Configuration)

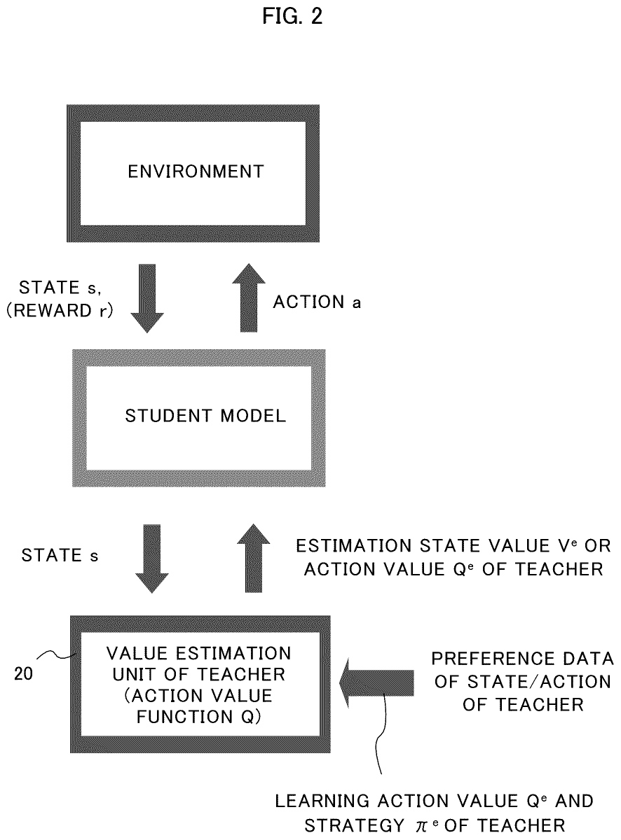

FIG. 2 is a block diagram showing aa functional configuration of the learning device 100. The learning device 100 performs learning of the student model by interacting with the environment and a value estimation unit 20 of the teacher. First, the learning device 100 generates the action value function Q of the teacher model by the technique described above using preference data of the state and the action of the teacher model. The value estimation unit 20 of the teacher uses the generated action value function Q.

The learning device 100 generates an action a based on the strategy π of a current student model and inputs the generated action a to the environment. Next, the learning device 100 acquires a state s and a reward r for the action a from the environment. In a case of interactive imitation learning of a type which does not use the reward r, the learning device 100 acquires only the state s from the environment.

Next, the learning device 100 inputs the state s acquired from the environment to the value estimation unit 20 of the teacher. The value estimation unit 20 of the teacher calculates an estimated value of a state value V^{e} or action value Q^{e} of the teacher model using the action value function Q. Specifically, in a case of performing the interactive imitation learning of the type which teaches the state value of the teacher model, the value estimation unit 20 of the teacher calculates an estimated value of the state value V^{e} of the teacher model. In addition, in a case of performing the interactive imitation learning of a type which teaches the action value of the teacher model, the value estimation unit 20 of the teacher calculates an estimated value of the action value Q^{e} of the teacher model. In the section (4-4-2-2) described above, the value estimation unit 20 of the teacher calculates the estimated value of the state value V^{e} of the teacher model using the action value function Q and the strategy π. The learning device 100 performs the interactive mimic learning using the estimated value of the state value V^{e} or action value Q^{e} of the teacher model, and updates the strategy π.

### (Student Model Learning Process)

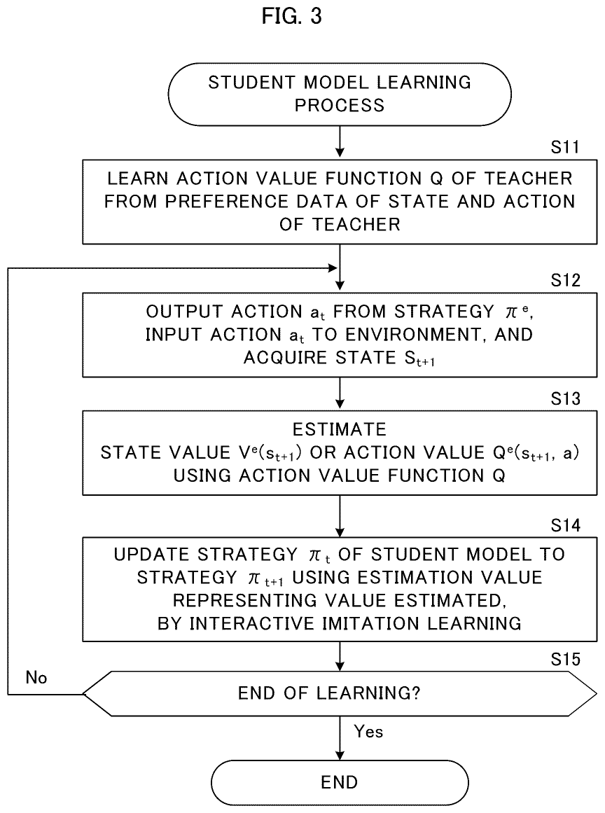

FIG. 3 is a flowchart of a student model learning process performed by the learning device 100. This student model learning process is realized by the processor 12 shown in FIG. 1 which executes a corresponding program or the like prepared in advance, and operates as each element shown in FIG. 2.

First, the learning device 100 acquires the preference data of the state and action of the teacher model, and learns the action value function Q of the teacher model in the technique described above (step S11). If desired, and specifically in the section (4-4-2-2) described above, the learning device 100 also learns a model of the strategy π^{e} of the teacher.

Next, the learning device 100 outputs an action at based on a strategy πₜ of the student model at that time, inputs the environment, and acquires a next state sₜ₊₁ from the environment (step S12).

Next, the learning device 100 inputs the status sₜ₊₁ into the value estimation unit 20 of the teacher and obtains an estimated value of a state value V^{e} (sₜ₊₁) or action value Q^{e}(sₜ₊₁, a) of the teacher model, using the action value function Q (step S13). If necessary, specifically in a case of the section (4-4-2-2) described above, the learning device 100 also uses the model of the policy π^{e} of the teacher and obtains an estimated value of the state value V^{e} (sₜ₊₁) of the teacher model.

Next, the learning device 100 performs the interactive imitation learning using the estimated value of the state value or action value of the teacher model, and updates the strategy πₜ of the student model to a strategy πₜ₊₁ (step S14). As a method of updating the strategy here, various kinds of methods commonly used in the reinforcement learning can be used.

Next, the learning device 100 determines whether the learning has been completed (step S15). Specifically, the learning device 100 determines whether or not a predetermined learning end condition is satisfied. If the learning has not completed (step S15: No), this student model learning process returns to step S12, processes of steps S12 to S14 are repeated. On the other hand, if the learning is completed (step S15: Yes), the student model learning process is terminated.

### Advantages

According to the technique of this example embodiment, it is possible to efficiently learn the student model by utilizing information of the teacher model as well as the existing interactive imitation learning. In addition, the technique of the present example embodiment allows learning from the teacher model with only off-line data indicating the preference of the state or action, unlike the existing interactive imitation learning.

In performing the interactive imitation learning, it may be difficult or expensive to prepare the offline data for the teacher model and the trajectory of the teacher that can be fed back online. For example, robot manipulation with many degrees of freedom and advanced language processes make it difficult for the teacher such as a human to behave as desired, and it is difficult to prepare the offline data of the trajectory (time series of states and actions) of the teacher. Even in such a case, the offline data (preference data) may be available for the teacher whose actions can be compared and determined if only the superiority or inferiority of the actions can be determined, i.e., the offline data indicate the preference of the state and action of the teacher. The technique of the present example embodiment makes use of such preference data to reduce searches from zero and make it possible to learn efficiently with less data.

In interactive imitation learning, there is a technique that allow efficient learning even from suboptimal teacher models while achieving performance that surpasses that of the teacher. For example, the technique described in Japanese Patent Application No. 2022-180115, proposed by the inventors of this invention based on the aforementioned THOR, is an example of this technique. The technique of this example embodiment can be combined with these methods, enabling the interactive imitation learning using the suboptimal teacher model that only has the preference data for the state and action.

### Second Example Embodiment

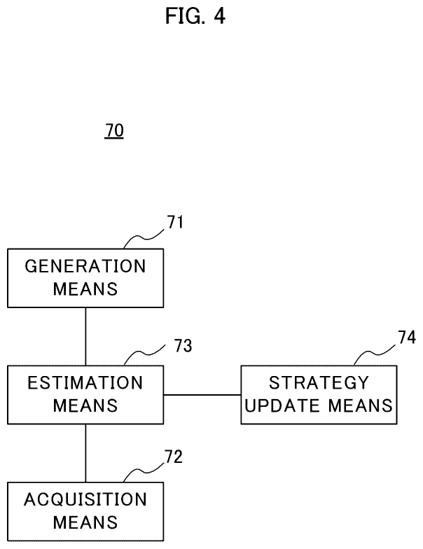

FIG. 4 is a block diagram illustrating a functional configuration of a learning device according to a second example embodiment. As illustrated in FIG. 4, a learning device 70 includes a generation means 71, an acquisition means 72, an estimation means 73, and a strategy update means 74.

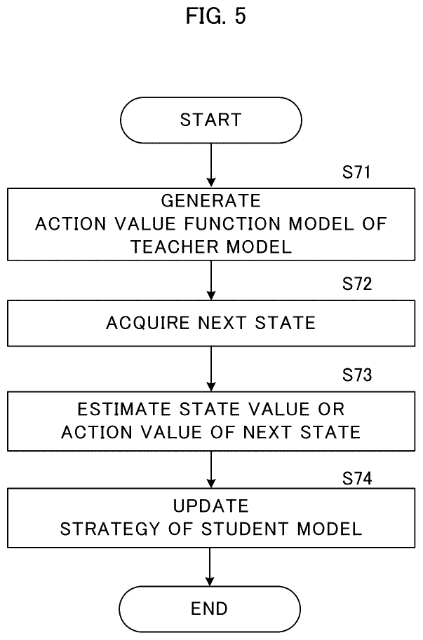

FIG. 5 is a flowchart of a process performed by the learning device according to the second example embodiment. The generation means 71 generates a value estimation model of a teacher model from preference data indicating a state and action of the teacher model and (step S71). The acquisition means 72 acquires a next state as an execution result of the action decided using the strategy of the student model (step S72). The estimation means 73 estimates the state value or action value of the next state using a following state and the value estimation model (step S73). The strategy update means 74 updates the strategy of the student model using the state value or action value (step S74).

According to the learning device 70 of the second example embodiment, if there is offline data indicating the preference of the state and action of the teacher model, it is possible to realize the interactive imitation learning.

### Application Example

An example in which the learning device of the present example embodiment is applied to learning of an autonomous driving model is described below. In this case, as the preference data, data from actual test runs by a human is used. In addition, a driving state of an automated vehicle is captured as selection of each and every driving operation (accelerator, brake, steering, etc.). Each driving operation is shown as a combination of a driving state s at a time and a driving operation (=behavior) a selected at the time. A score of each driving operation is expressed by a value function Q(s,a) which represents a value expected in the future driving excellence (safety, efficiency, etc.) starting from that driving operation.

First, in comparison to two driving operations (s,a) and (s′, a′), the probability that (s,a) is preferable is expressed using a difference between scores of the two driving operations. A probability model in which an operation with a higher score has a higher probability of being chosen is denoted by p.

Also, the value function Q is expressed using a parameter θ, and the probability model p is also expressed by the parameter θ. The parameter θ is optimized using human test operation data to learn the value function Q. In this case, preference data for several driving operations for the same driving state is collected to form the preference data for each driving operation. In addition, by expressing the probability model p in terms of a driving strategy π of the teacher model, it is also possible to learn the driving strategy π of the teacher model.

The learning device uses the value function Q learned using the test driving data of the teacher model as a value function of the teacher of the autonomous driving model to perform the interactive imitation learning. Specifically, in a case where the autonomous driving model queries the action value Q^{e}(s,a) of the driving operation a of the teacher model in the driving state s, the learning device calculates Q(s,a) using the learned value function Q and estimates the action value Q^{e}(s,a).

In a case where the autonomous driving model queries a state value V^{e}(s) of the driving state s of the teacher model in the driving state s, the learning device calculates the state value V^{e}(s) as follows, depending on a number of possible operational operations.

(i) Situation where the Number of Possible Driving Operations is Small:

The learning device calculates a sum of the operating values as the state value V^{e}(s) using a first expression (formula (16)), which calculates the state value V from the learned value function Q.

(ii) Situation where the Number of Possible Driving Operations is Large:

The learning device also learns the driving strategy π of the teacher model. Then, the learning device obtains the state value V^{e}(s) by approximating a second expression (formula (17)), which calculates an expected value of the state value V using the learned value function Q and the driving strategy π with the samples generated from the operation strategy π.

Note that, the application of the interactive imitation learning of the present example embodiment is not limited to the autonomous driving described above, but can be applied to various applications such as manipulations of robots, drones, etc., language processing, and the like.

A part or all of the example embodiments described above may also be described as the following supplementary notes, but not limited thereto.

### Supplementary Note 1

A learning device comprising:
a generation means configured to generate a value estimation model from preference data indicating combinations of each state and action;
an acquisition means configured to acquire a next state as an execution result of an action determined using a strategy of a learning target model; and
an estimation means configured to estimate a state value or action value of a next state using the next state and the value estimation model; and
a strategy update means configured to update the strategy of the learning target model using the state value or the action value.

### Supplementary Note 2

The learning device according to supplementary note 1, wherein the generation means
generates a probability model indicating a probability of preference between the combinations of each state and action,
parametrizes the value estimation model and the probability model with a common parameter, and
generates the value estimation model by optimizing the common parameter using the preference data.

### Supplementary Note 3

The learning device according to supplementary note 2, wherein the generation means
considers the probability model as a probability model of binary classification, which selects one combination from two combinations of each state and action at a given time, and
optimizes the common parameter to minimize a loss of the binary classification.

### Supplementary Note 4

The learning device according to supplementary note 1, wherein the strategy update means updates the strategy of the learning target model by interactive imitation learning.

### Supplementary Note 5

The learning device according to supplementary note 4, wherein the estimation means estimates the action value of a next state using the next state and the value estimation mode, in a case where the interactive imitation learning uses the action value.

### Supplementary Note 6

The learning device according to supplementary note 4, wherein the estimation means estimate the state value of a next state in a case where the interactive imitation learning uses the state value.

### Supplementary Note 7

The learning device according to supplementary note 6, wherein the estimation means estimates the state value of the next state using the next state, the value estimation model, a first expression representing a relationship between the value estimation model and the state value.

### Supplementary Note 8

The learning device according to supplementary note 6, wherein
the generation means generates a model of the strategy from the preference data, and
the estimation means estimates the state value of the next state, the value estimation model, the model of the strategy, a second expression representing a relationship between the value estimation model, the strategy, and the state value.

### Supplementary Note 9

A learning method performed by a computer, comprising:
generating a value estimation model from preference data indicating combinations of each state and action;
acquiring a next state as an execution result of an action determined using a strategy of a learning target model; and
estimating a state value or action value of a next state using the next state and the value estimation model; and
updating the strategy of the learning target model using the state value or the action value.

### Supplementary Note 10

A recording medium storing a program causing a computer to execute processing of:
generating a value estimation model from preference data indicating combinations of each state and action;
acquiring a next state as an execution result of an action determined using a strategy of a learning target model; and
estimating a state value or action value of a next state using the next state and the value estimation model; and
updating the strategy of the learning target model using the state value or the action value.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

This application is based upon and claims the benefit of priority from Japanese Patent Application 2024-097467, filed on Jun. 17, 2024, the disclosure of which is incorporated herein in its entirety by reference.

### DESCRIPTION OF SYMBOLS

12 Processor
20 Value estimation unit
71 Generation means
72 Acquisition means
73 Estimation means
74 Strategy update means

1. A learning device comprising:
at least one memory configured to store instructions; and
at least one processor configured to execute the instructions to:
generate a value estimation model from preference data indicating combinations of each state and action;
acquire a next state as an execution result of an action determined using a strategy of a learning target model; and
estimate a state value or action value of a next state using the next state and the value estimation model; and
update the strategy of the learning target model using the state value or the action value.

2. The learning device according to claim 1, wherein the at least one processor
generates a probability model indicating a probability of preference between the combinations of each state and action,
parametrizes the value estimation model and the probability model with a common parameter, and
generates the value estimation model by optimizing the common parameter using the preference data.

3. The learning device according to claim 2, wherein the at least one processor
considers the probability model as a probability model of binary classification, which selects one combination from two combinations of each state and action at a given time, and
optimizes the common parameter to minimize a loss of the binary classification.

4. The learning device according to claim 1, wherein the at least one processor updates the strategy of the learning target model by interactive imitation learning.

5. The learning device according to claim 4, wherein the at least one processor estimates the action value of a next state using the next state and the value estimation mode, in a case where the interactive imitation learning uses the action value.

6. The learning device according to claim 4, wherein the at least one processor estimates the state value of a next state in a case where the interactive imitation learning uses the state value.

7. The learning device according to claim 6, wherein the at least one processor estimates the state value of the next state using the next state, the value estimation model, a first expression representing a relationship between the value estimation model and the state value.

8. The learning device according to claim 6, wherein the at least one processor
generates a model of the strategy from the preference data, and
estimates the state value of the next state using the next state, the value estimation model, the model of the strategy, a second expression representing a relationship between the value estimation model, the strategy, and the state value.

9. A learning method performed by a computer, comprising:
generating a value estimation model from preference data indicating combinations of each state and action;
acquiring a next state as an execution result of an action determined using a strategy of a learning target model;
estimating a state value or action value of a next state using the next state and the value estimation model; and
updating the strategy of the learning target model using the state value or the action value.

10. A non-transitory computer-readable recording medium storing a program causing a computer to execute processing of:
generating a value estimation model from preference data indicating combinations of each state and action;
acquiring a next state as an execution result of an action determined using a strategy of a learning target model;
estimating a state value or action value of a next state using the next state and the value estimation model; and
updating the strategy of the learning target model using the state value or the action value.
